(19) United States
(12) Patent Application Publication
(10) Pub. No.: US 2018/0184450 A1
(43) Pub. Date: Jun. 28, 2018

(54) SYSTEM AND METHODS TO CONFIGURE CONTENTION-BASED ACCESS PERIODS TRANSMISSION RULES TO ENABLE TIME SENSITIVE APPLICATIONS IN AN IEEE 802.11 WLAN

(71) Applicants: Dave A. Cavalcanti, Portland, OR (US); Carlos Cordeiro, Portland, OR (US)

(72) Inventors: Dave A. Cavalcanti, Portland, OR (US); Carlos Cordeiro, Portland, OR (US)

(21) Appl. No.: 15/391,579

(22) Filed: Dec. 27, 2016

(51) Int. Cl. H04W 74/08; H04W 16/28

(52) U.S. Cl. CPC H04W 74/08; H04W 16/28

(57) ABSTRACT

A wireless communication station, method, and related computer program product are provided for communicating over a wireless communication medium. The station comprises an allocation unit configured to allocate a dedicated time-sensitive network (TSN) contention-based-access-period (CBAP) to a first pair of stations (STAs) to allow a synchronous TSN traffic flow between the first pair of STAs. The allocation unit allocates a shared TSN CBAP to a second pair of STAs to allow an asynchronous TSN traffic flow between the second pair of STAs using contention-based rules. The allocation unit allocates a shared non-TSN CBAP to a third pair of STAs to allow a non-TSN traffic flow between the third pair of STAs. The station further transmits over the wireless communication medium, a scheduling element to schedule a dedicated TSN CBAP, a scheduling element to schedule a shared TSN CBAP, and a scheduling element to schedule a shared non-TSN CBAP.

### TECHNICAL FIELD

The present disclosure relates to devices and methods to configure contention-based access periods transmission rules to enable time sensitive applications in an IEEE 802.11 WLAN.

### BACKGROUND

Time Sensitive Networks (TSN) are networks that provide time synchronization and timeliness (deterministic latency and reliability/redundancy) guarantees to critical data flows. Traditionally, TSN applications have been using wired connectivity (e.g., Ethernet TSN). However, wiring has several limitations (e.g. high maintenance cost, weight, limited mobility). It would be beneficial to enable TSN-grade performance over wireless networks (i.e., wireless TSN (WTSN)). Many TSN applications (e.g., automotive and industrial control) would benefit from use of a WTSN.

In some wireless communication networks, communication may be performed during beacon intervals (BI), which may be scheduled, for example, according to a beacon and/or an announcement frame. A BI may be divided, for example, into a plurality of access periods, and different access periods within the BI may have different access rules.

For example, the BI may include at least one access period, for example, a Data Transfer Time (DTT), which may be allocated for frame exchanges between a plurality of wireless communication devices, for example, stations (STAs). The DTT may include one or more contention-based access periods (CBAPs) and/or one or more service periods (SPs). During the CBAP stations may be allowed to communicate using a suitable contention-based mechanism, for example, an Enhanced Distributed Channel Access (EDCA) mechanism.

### BRIEF DESCRIPTION OF THE DRAWINGS

FIG. 1A is a block diagram of system using wireless communication devices, in accordance with some aspects;

FIG. 1B is a data structure diagram that illustrates a beacon frame, in accordance with some aspects;

FIG. 1C is a pictorial diagram illustrating an example of a WTSN scenario showing TSN and non-TSN flows in an industrial control network:

FIG. 2 is a timing diagram that illustrates a method to reserve SPs for ultra-low latency synchronous TSN flows on a dedicated/secondary TSN channel without overlapping with required control/management frame exchanges, in accordance with some aspects of the inventive subject matter;

FIG. 3 is a timing diagram that illustrates AP allocated dedicated CBAPs to synchronous TSN flows (TSN CBAP) and shared CBAPs that may be used for both asynchronous events and non-TSN data, in accordance with some aspects of the inventive subject matter:

FIG. 4 is a timing diagram illustrating the TSN CBAPs 310 access rules, in accordance with some aspects of the inventive subject matter;

FIG. 5 is a timing diagram illustrating access rules for TSN STAs in shared CBAPs:

FIG. 6 is a flowchart illustrating a method of forming dedicated CBAPs for synchronous TSN flows, and shared CBAPs that may be used for both asynchronous events and non-TSN data, in accordance with some aspects of the inventive subject matter; and

FIGS. 7A and 7B are block diagrams illustrating an article of manufacture, in accordance with some aspects of the inventive subject matter.

### DETAILED DESCRIPTION

The following is a detailed description of various embodiments and configurations depicted in the accompanying drawings. However, the amount of detail offered is not intended to limit anticipated variations of the described configurations; to the contrary, the claims and detailed description are to cover all modifications, equivalents, and alternatives falling within the spirit and scope of the present teachings as defined by the claims. The detailed descriptions below are designed to make such configurations understandable to a person having ordinary skill in the art.

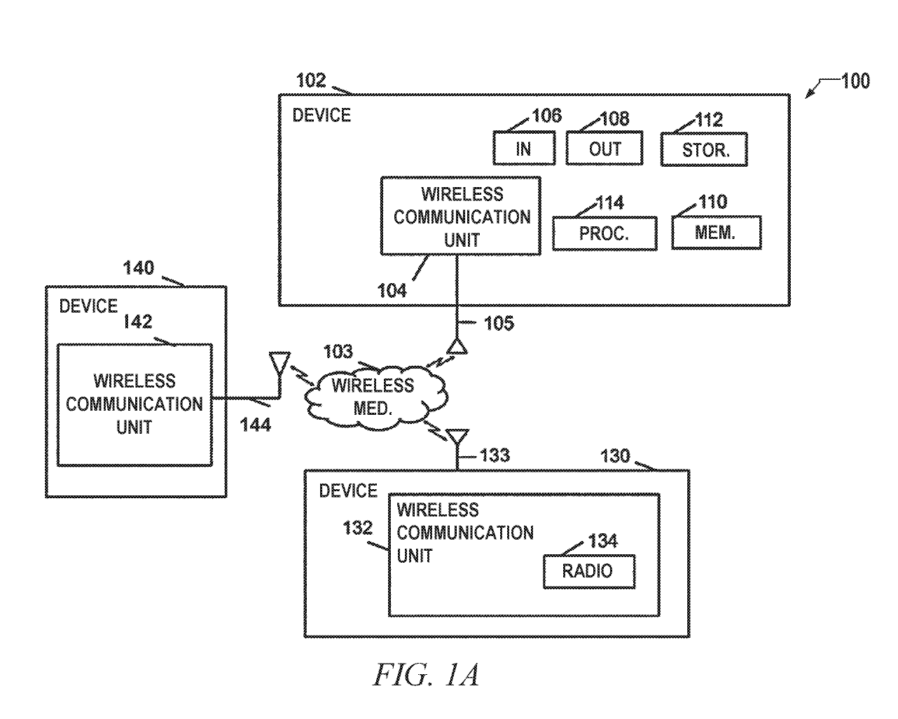

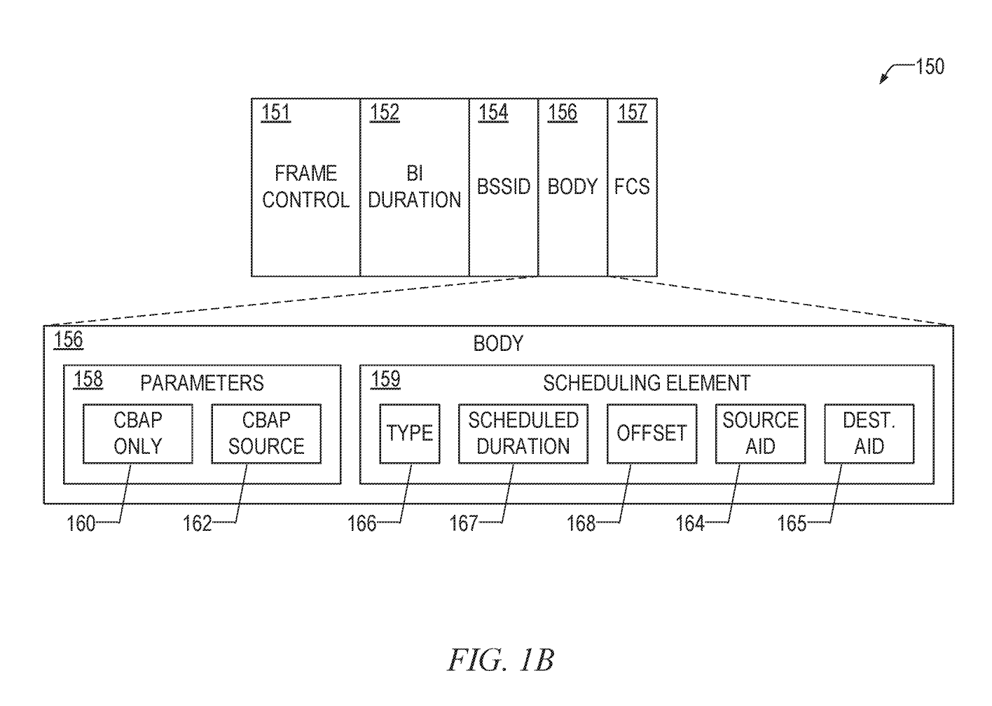

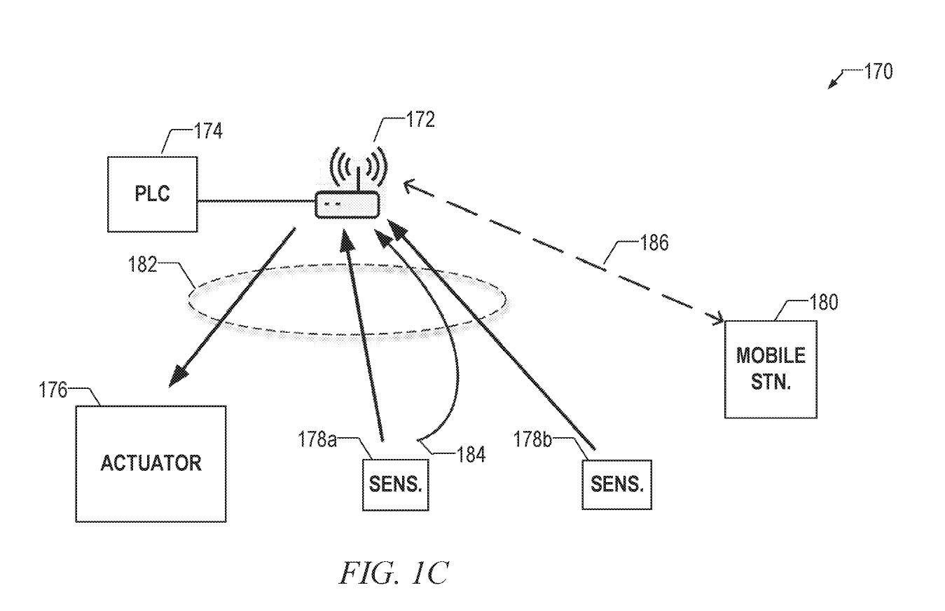

Reference is now made to FIG. 1A, which schematically illustrates a block diagram of a system 100, in accordance with some demonstrative aspects.

As shown in FIG. 1A, in some embodiments, system 100 may include a wireless communication network including one or more wireless communication devices, for example, wireless communication devices 102, 140 and/or 130, capable of communicating content, data, information and/or signals over a wireless communication medium 103, for example, a radio channel, an IR channel, a RF channel, a Wireless Fidelity (Wi-Fi) channel, and the like. One or more elements of system 100 may optionally be capable of communicating over any suitable wired communication links.

In some embodiments, wireless communication devices 102, 140 and/or 130 may include, for example for TSN applications, programmable logic controllers (PLCs), sensors, and actuators. In a more general sense, these devices may include, for example, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some embodiments, wireless communication devices 102, 140 and/or 130 may include wireless communication units 104, 142 and/or 132, respectively, to perform wireless communication between wireless communication devices 102, 140 and/or 130 and/or with one or more other wireless communication devices, for example, as described below.

Wireless communication devices 102, 140 and/or 130 may also include, for example, one or more of a processor 114, an input unit 106, an output unit 108, a memory unit 110, and a storage unit 112. Wireless communication devices 102, 140 and/or 130 may optionally include other suitable hardware components and/or software components. In some embodiments, some or all of the components of one or more of wireless communication devices 102, 140 and/or 130 may be enclosed in a common housing or packaging, and may be interconnected or operably associated using one or more wired or wireless links. In other embodiments, components of one or more of wireless communication devices 102, 140 and/or 130 may be distributed among multiple or separate devices.

Processor 114 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 114 executes instructions, for example, of an Operating System (OS) of wireless communication devices 102, 140 and/or 130 and/or of one or more suitable applications.

Input unit 106 includes, for example, a keyboard, a keypad, a mouse, a touch-screen, a touch-pad, a track-ball a stylus, a microphone, or other suitable pointing device or input device. Output unit 108 includes, for example, a monitor, a screen, a touch-screen, a flat panel display, a Cathode Ray Tube (CRT) display unit, a Liquid Crystal Display (LCD) display unit, a plasma display unit, one or more audio speakers or earphones, or other suitable output devices.

Memory unit 110 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 112 includes, for example, a hard disk drive, a floppy disk drive, a Compact Disk (CD) drive, a CD-ROM drive, a DVD drive, or other suitable removable or non-removable storage units. Memory unit 110 and/or storage unit 112, for example, may store data processed by wireless communication devices 102, 140 and/or 130.

In some embodiments, wireless communication units 104, 142 and 132 may include, or may be associated with, one or more antennas 105, 144 and 133, respectively. Antennas 105, 144 and/or 133 may include any type of antennas suitable for transmitting and/or receiving wireless communication signals, blocks, frames, transmission streams, packets, messages and/or data. For example, antennas 105, 144 and/or 133 may include any suitable configuration, structure and/or arrangement of one or more antenna elements, components, units, assemblies and/or arrays. Antennas 105, 144 and/or 133 may include, for example, antennas suitable for directional communication, for example, using beamforming techniques. For example, antennas 105, 144 and/or 133 may include a phased array antenna, a single element antenna, a set of switched beam antennas, and/or the like. In some embodiments, antennas 105, 144 and/or 133 may implement transmit and receive functionalities using separate transmit and receive antenna elements. In some embodiments, antennas 105, 144 and/or 133 may implement transmit and receive functionalities using common and/or integrated transmit/receive elements.

In some embodiments, wireless communication units 104, 142 and/or 132 include, for example, one or more radios 134, for example, including one or more wireless transmitters, receivers and/or transceivers able to send and/or receive wireless communication signals, RF signals, frames, blocks, transmission streams, packets, messages, data items, and/or data. For example, wireless communication units 104, 144 and/or 132 may include or may be implemented as part of a wireless Network Interface Card (NIC), and the like.

In some embodiments, wireless communication devices 102, 140 and 130 may establish a wireless communication link. The link may include an uplink and/or a downlink. The downlink may include, for example, a unidirectional link from an AP to one or more non-AP stations (STAs) or a unidirectional link from a non-AP Destination STA to a non-AP Source STA. The uplink may include, for example, a unidirectional link from a non-AP STA to an AP or a unidirectional link from a non-AP Source STA to a non-AP Destination STA.

In some embodiments, wireless communication devices 102, 140 and/or 130 may perform the functionality of DMG stations (“DMG STA”). For example, wireless communication devices 102, 140 and/or 130 may be configured to communicate over the DMG band.

In some embodiments, system 100 may include a PCP/AP STA and one or more non-PCP/AP STAs. In one example, device 140 may perform the functionality of a PCP/AP STA, and/or devices 102 and/or 130 may perform the functionality of non-PCP/AP STAs. In another example, device 102 may perform the functionality of a PCP/AP STA, and/or devices 130 and/or 140 may perform the functionality of non-PCP/AP STAs.

In some embodiments, a CBAP may be allocated for communication between two or more of devices 102, 140 and/or 130 according to a suitable contention-based mechanism, for example, EDCA or any other contention mechanism.

In some embodiments, the CBAP may be allocated by a PCP/AP STA. For example, the PCP/STA may transmit a scheduling element allocating the CBAP, for example, as described below. The scheduling element may be included as part of a beacon frame or any other frame, which may be transmitted, for example, by the PCP/AP STA, for example, by device 140. In one example, a STA, for example, device 140, operating as a PCP/AP STA may communicate a scheduling of a BI (BI scheduling) as part of a beacon frame, an announce frame and the like. A STA, for example, devices 102 and/or 130, operating as a non-PCP/AP STA may receive the BI scheduling and may access wireless medium 103 during scheduled periods of the scheduled BI.

In some embodiments, the CBAP may be allocated for communication by only two STAs, for example, devices 102 and 130. In other demonstrative embodiments, the CBAP may be allocated for communication between more than two STAs. In some embodiments, a STA, for example, device 102, 130 and/or 140, may communicate a scheduling element to schedule a CBAP (“allocated unicast CBAP”) for communication between only two wireless communication stations. For example, a device, (e.g., device 140), performing the functionality of a PCP/AP STA may transmit the scheduling element, for example, as part of beacon frame, an announce frame, or any other frame, for scheduling the allocated unicast CBAP, and one or more devices performing the functionality of a non-PCP/AP STA, for example, devices 102 and/or 130, may receive the scheduling element scheduling the allocated unicast CBAP.

In some embodiments, the scheduling element may define a first STA of the two STAs as a source STA and a second STA of the two STAs as a destination STA. In some embodiments, the scheduling element may include a first field, for example, a source field, which may include an identification of the source STA, and a second field, for example, a destination field, which may include an identification of the destination STA. In some embodiments, the scheduling element may include a source association identification (AID) field including an AID of the first STA, for example, a unicast AID of device 102, and a destination AID field including an AID of the second STA, for example, a unicast AID of device 130.

In one example, device 140 may perform the functionality of a PCT/AP STA, and may transmit a beacon allocating a unicast CBAP for communication between devices 102 and 130. For example, the beacon may include a scheduling element with a source AID field, which includes an AID of device 102, and a destination AID field, which include an identification of device 130. In other demonstrative embodiments, the scheduling element may include any other source field including any other identification of the source STA and/or any other destination field including any other identification of the destination STA. For example, the scheduling element may include any STA identifiers uniquely identifying the source STA and/or the destination STA, for example, within a PBSS.

Reference is now made to FIG. 1B, which schematically illustrates a beacon frame 150, which may be used to schedule a beacon interval, in accordance with some demonstrative embodiments. In some embodiments, beacon frame 150 may be transmitted by a device, for example, device 102, 130 and/or 160 (FIG. 1A), performing the functionality of a PCP/AP STA. In some embodiments, beacon frame 150 may include a frame control field 151, a BI duration field 152, a BSS identifier (BSSID) field 154, a portion 156 (“body”) and a frame check sequence 157. In some embodiments, BI duration field 152 may indicate duration of the beacon interval, and/or BSSID field may include an identification of the BSS for which the beacon interval is scheduled.

In some embodiments, body 156 may include a parameter field (also referred to as “Dband parameter field” or “constant parameter field”) 158 including a plurality of parameters to be applied during the beacon interval. In some embodiments, parameter field 158 may include, for example, a CBAP only field 160 to indicate a type of link access, for example, provided by a STA sending beacon frame 150, during a DTT of the beacon interval. In some embodiments, CBAP only field 160 may indicate, for example, whether or not the entire DTT is to be allocated to a CBAP. For example, CBAP only field 160 may be set to a first predefined value, for example, one, to indicate the entire DTT is to be allocated to a CBAP; or a to a second predefined value, for example, zero, to indicate that the DTT is allocated to be used by different STAs using different access methods. The allocation may be provided by scheduling elements that may be included in the beacon or in other frames, for example, an announce frame.

In some embodiments, parameter field 158 may include a CBAP source field 162 to indicate whether or not only a PCP/AP STA transmitting beacon frame 150 may be allowed to initiate transmissions during the CBAP. For example, CBAP source field 162 may include a first value, for example, one, to indicate that only the PCP/AP station may be allowed to initiate transmissions during the CBAP, or a second predefined value, for example, zero, to indicate that any STA in the BSS may initiate transmission during the CBAP.

In some embodiments, body 156 may include at least one scheduling element 159 to allocate at least one scheduled period (interval) during a DTT of the beacon interval. In some embodiments, scheduling element 159 may allocate one or more CBAPs.

In some embodiments, scheduling element 159 may include a type field 166 to indicate the scheduled interval relates to a CBAP, a duration field 167 to indicate a duration of the scheduled interval, and an offset field 168 to indicate an offset of the scheduled interval within the BI.

In some embodiments, scheduling element 159 may include a CBAP source field 164, which may include an AID of a source STA defined for an allocated CBAP; and a CBAP destination field 165, which may include an AID of a destination STA allocated for the CBAP, for example, as described herein.

In some embodiments, scheduling element 159 may allocate a unicast CBAP, for example, a unicast CBAP between devices 102 and 130 (FIG. 1A), by setting source AID field 164 to include a first AID of a first STA, for example, a unicast AID of device 102 (FIG. 1A), and destination AID field 165 to include a unicast AID of the second STA, for example, a unicast AID of device 130 (FIG. 1A).

In some embodiments, scheduling element 159 may be included as part of any other frame configured to allocate a CBAP, for example, scheduling element 159 may be included as part of an announce frame.

Referring back to FIG. 1A, in some embodiments, a higher priority for sending a transmission may be provided to a selected STA scheduled of a CBAP, for example, over all other STAs scheduled for the CBAP.

In some embodiments, when the CBAP is scheduled for only two STAs, a first selected STA of the source STA and destination STA may be provided with a higher priority over a second selected STA of the source STA and destination STA for communicating during the CBAP.

In some embodiments, the first selected STA may include the source STA, for example, as indicated by source AID field 164 (FIG. 1B), and the second selected STA may include the destination STA, for example, as indicated by destination AID field 165 (FIG. 1B), for example, such that the source STA may be provided with a higher priority over the destination STA, for example, as described below. However, in other embodiments, the first selected STA may include the destination STA, and the second selected STA may include the source STA, for example, such that the destination STA may be provided with a priority over the source STA

In some embodiments, the higher priority may include allowing the first selected STA, for example, the source STA, to transmit a wireless transmission upon determining, for example, immediately after determining, that the wireless communication medium 103 is idle for a first predefined time period within the CBAP, for example, while all other STAs scheduled for the CBAP, for example, the destination STA, may not be allowed to transmit during the predefined time period or immediately after the predefined time period.

For example, all other STAs scheduled for the CBAP, for example, the destination STA, may be allowed to transmit a transmission after determining that the wireless communication medium 103 is idle for a second predefined time period, for example, longer than the first time period. For example, the other STAs scheduled for the CBAP, for example, the destination STA, may be allowed to transmit the transmission after determining that the wireless communication medium 103 is idle for the second predefined time period and counting a back-off (BO) period, for example, as described below.

In some embodiments, the first time period may include a point inter frame space (PIFS) period and/or the second time period may include a distributed inter frame space (DIFS) period. In other embodiments, the first and/or second time periods may include any other periods.

In some embodiments, providing the higher priority to the first selected STA may include allowing the first selected STA, for example, the source STA, to transmit the wireless communication transmission upon determining, for example, immediately after determining, that the wireless communication medium 103 is idle for the first predefined time period after a Transmit Opportunity (TxOp).

In some embodiments, providing the higher priority to the first selected STA may include allowing the first selected STA, for example, the source STA, to transmit the wireless communication transmission upon determining, for example, immediately after determining, that the wireless communication medium 103 is idle for the first predefined time period measured following the beginning of the scheduled CBAP.

In some embodiments, a wireless communication station, for example, device 102, may transmit a wireless communication transmission over wireless communication medium 103 upon determining, for example, immediately after determining, that the wireless communication medium 103 is idle for the first predefined time period within a CBAP, if a scheduling element allocating the CBAP, for example, scheduling element 159 (FIG. 1B), includes an indication of an identity of the wireless communication station in a predefined field, for example, the source field 164 (FIG. 1B).

In some embodiments, the predefined field may include the source AID field. For example, device 102 may be allowed to transmit a wireless transmission over medium 103 after determining that the wireless communication medium 103 is idle for the PIFS within a CBAP, for example, measured from the beginning of the CBAP and/or following a TxOP, only if the scheduling element, for example, scheduling element 159 (FIG. 1B), allocating the CBAP to device 102 includes the AID of device 102 in field 164 (FIG. 1B).

In some embodiments, if the scheduling element does not include the indication of the identity of the wireless communication station in the predefined field, then the wireless communication station may be allowed to transmit the transmission after a time period longer than the first time period, for example, if the scheduling element includes the indication of the identity of the wireless communication station in another predefined field, for example, the destination field 165 (FIG. 1B).

In some embodiments, the wireless communication station may be allowed to transmit the transmission after waiting a back-off period following the second period, which is longer than the first period. For example, device 102 may be allowed to begin counting the back-off period after determining that the wireless communication medium 103 is idle for the DIFS within the CBAP, for example, measured from the beginning of the CBAP and/or following a TxOP, only if the scheduling element allocating the CBAP to device 102, for example, scheduling element 159 (FIG. 1B), includes the AID of device 102 in the destination field 165 (FIG. 1B).

In some embodiments, the back-off period may be determined based on a random number, for example, the back-off period may have a duration of SlotTime*random_number, wherein SlotTime denotes a predefined constant time period. The random number may be selected, for example, from an interval 0-2^{CW}, wherein CW denotes a contention window. The wireless communication station may be allowed to transmit the transmission immediately after the DIFS period, for example, if the back-off period is zero, or at a later time after the DIFS period, for example, if the back-off is greater than zero.

In some embodiments, the PCP/AP STA scheduling the CBAP may also be allowed, in some circumstances, to transmit a transmission upon determining, for example, immediately after determining, that the wireless communication medium is idle for the first time period within the CBAP, for example, as described below.

In some embodiments, a device performing the functionality of a PCP/AP STA, for example, device 160, may be allowed to transmit a wireless transmission over wireless communication medium 103 upon determining, for example, immediately after determining, that the wireless communication medium 103 is idle for the first time period within the CBAP, for example if an entire data transfer time (DTT) is allocated to the CBAP.

In some embodiments, the PCP/AP station may be allowed to transmit the wireless transmission upon determining, for example, immediately after determining, that the wireless communication medium 103 is idle for the first time period within the CBAP, for example, if the scheduling element, for example, scheduling element 159 (FIG. 1B), includes a CBAP-only field, for example, field 160 (FIG. 1B), having a value, for example, one, indicating that the entire DTT is allocated to the CBAP, and a CBAP-source field, for example, field 162 (FIG. 1B), having a value, for example, one, indicating that only the PCP/AP station is allowed to initiate transmissions during the CBAP.

In some embodiments, a STA, for example, devices 102, 160 and/or 130, may not be allowed to transmit within a unicast CBAP, for example, unless an AID of the STA is equal to the value of a destination AID field, for example, field 165 (FIG. 1B), of the scheduling element allocating the CBAP, for example, scheduling element 159 (FIG. 1A); if the AID of the STA is equal to the value of the source AID field, for example, field 164 (FIG. 1B), of the scheduling element; or if the STA performs the role of a PCP/AP STA, and both the CBAP only field, for example, field 160 (FIG. 1B), in a beacon, beacon frame 150 (FIG. 1B), allocating the CBAP, is equal to one, and a CBAP source field, for example, CBAP source field 162 (FIG. 1B), of the beacon is equal to one.

In some embodiments, if the AID of the STA is equal to the value of the source AID field, or if the STA performs the role of a PCP/AP STA, and both the CBAP only field and the CBAP source field are equal to one, then the STA may be allowed to initiate a transmission within the CBAP immediately after determining that the wireless communication medium 103 is idle for the PIFS period, for example, as described above.

TSN applications may include a mix of traffic patterns and requirements:
a) Synchronous TSN data flows (e.g., between sensors, actuators, and controllers in a closed loop control system) have hard real-time latency requirements. Each TSN flow may generate a deterministic synchronous data stream with a fixed packet size and inter-arrival period, which may range from tens of microseconds to a few milliseconds.
b) Asynchronous events (e.g., events triggered by equipment failure or sensor information crossing a given threshold), which usually comprises a single report to be delivered to a monitoring/supervision system. The typical latency requirements for events is in the order of hundreds of milliseconds, and therefore these are not as time critical as some critical synchronous flows. However, reliability is still a major requirement for asynchronous events.
c) Monitoring data which includes periodic or event triggered measurement reports. These are not time sensitive (non-TSN) and may use a best effort connectivity service.

FIG. 1C is a pictorial diagram illustrating an example of a WTSN scenario showing TSN and non-TSN flows in an industrial control network 170. An access point 172 may be in communication with a programmable logic controller 174 and an actuator 176 that might control a robotic arm Two sensors 178a, 178b are present that may be used to provide information about environmental conditions, such as temperature and noise level. The network may also comprise a mobile station 180 that provides a user interface for connecting with the industrial control network 170. The dashed ellipse 182 shows the TSN flows in the network, which may include an asynchronous event 184 from one of the sensors 178a, but TSN flows may include synchronous data streams as well. The mobile station 180 may communicate within the industrial control network 170 using non-TSN traffic 186.

Wi-Fi/802.11 connectivity in millimeter wave bands (e.g., the 60 GHz frequency band) is a potential candidate, as discussed above, to support TSN-grade requirements with high reliability, as well as non-TSN grade traffic. The 802.11 ad standard (publication ISO/IEC/IEEE 8802.11 Amendment 3 published Mar. 15, 2014), which defines the media access control (MAC) and physical (PHY) modes for operation in the 60 GHz frequency band, includes a reservation-based MAC layer mode that enables dedicated Service Periods (SPs) to be assigned to TSN traffic. The IEEE 802.11ad standard supports a contention-based mode in which an access point (AP) may define a Contention-Based Access Period (CBAP) where stations (STAs) use the EDCA contention-based access rules and parameters.

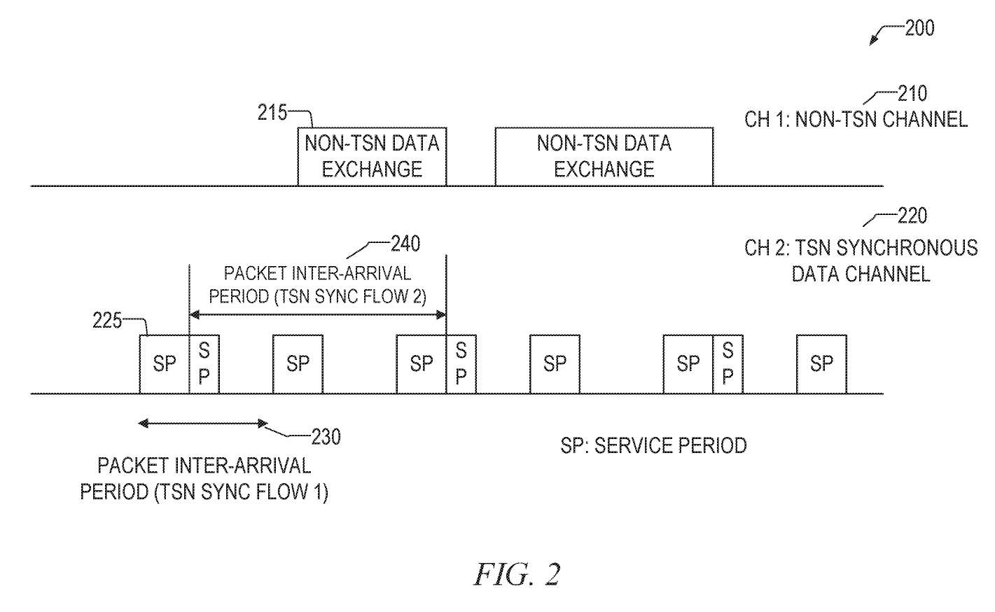

FIG. 2 is a timing diagram 200 that illustrates an example of a method to reserve SPs for ultra-low latency synchronous TSN flows. The non-TSN data exchange takes place in a non-TSN channel 210 in non-TSN data exchange communications 215. The TSN flows take place on a dedicated/secondary TSN channel 220 during service periods (SPs) 225 without overlapping with required control/management frame exchanges. Resource reservation is a method that may be used to support TSN-grade requirements. FIG. 2 illustrates that multiple TSN flows may exist within the network, and that each TSN flow has a specific packet inter-arrival period. This means that the flow has SPs at the same periodicity.

The concept of dedicated/contention-free SPs is defined in the IEEE 802.11 lad standard and it is not the most efficient method to support asynchronous traffic patterns such as asynchronous events, which are randomly generated.

On the other hand, contention-based access, which is the default access method across several IEEE 802.11 modes and frequency bands, is a more efficient way to serve asynchronous events and monitoring traffic. Therefore, it would be desirable to adapt existing contention-based access mechanisms to support both synchronous TSN and asynchronous events and monitoring traffic requirements.

The following describes methods that may be used to adapt the CBAP access rules defined in the IEEE 802.1 lad standard, IEEE std. 802.11ad-2012, published Dec. 28, 2012 to support both TSN synchronous flows as well as asynchronous events and monitoring traffic (non-TSN) with high reliability. In these methods, CBAPs may be used to enable both deterministic reservations for synchronous TSN flows, as well as non-TSN traffic including asynchronous events and other non-TSN traffic patterns by configuring the access rules and parameters for CBAPs according to the required quality of service (QoS). Doing this may simplify the MAC design and implementation. This concept may also be extended to other IEEE 802.11 modes and frequency bands.

The following assumes that the TSN capable network operates in a managed environment without unmanaged nearby Wi-Fi networks. This is a reasonable assumption for many industrial and enterprise environments where the TSN application may be of most use. The following further assumes that an STA with critical TSN flows (referred to hereafter as a TSN STA) requests access with certain QoS requirements (e.g., those defined in a TSPEC, which allows a wireless client to signal its traffic requirements to the AP) that characterizes the TSN requirements. The AP would, therefore, be aware of TSN traffic streams.

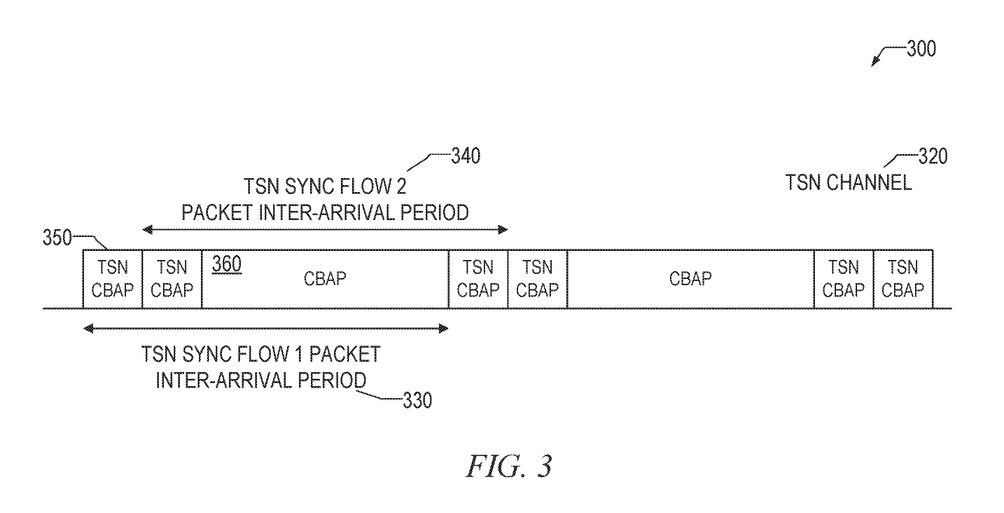

FIG. 3, which is a timing diagram 300, illustrates CBAP allocations in a dedicated TSN channel 320. In order to support mixed TSN synchronous flows, asynchronous events and non-TSN data, the AP may allocate dedicated CBAPs to synchronous TSN flows (TSN CBAP) 350 and shared CBAPs 360 that may be used for both asynchronous events and non-TSN data. The TSN CBAPs 350 may be allocated to specific STAs by setting the source 164 and destination 165 AID fields of the TSN CBAP 350. On the other hand, the shared CBAP 360 may be configured to allow multiple STAs to transmit using contention-based access rules. The TSN sync flow 1 packet inter-arrival period 330 and the TSN sync flow 2 packet inter-arrival period illustrate an example where multiple synchronous TSN flows may be active within the network, where each flow has a pre-defined packet inter-arrival period (a data packet is transmitted with a given periodicity) and therefore multiple TSN CBAPs are scheduled to serve the two flows, shown back to back in FIG. 3.

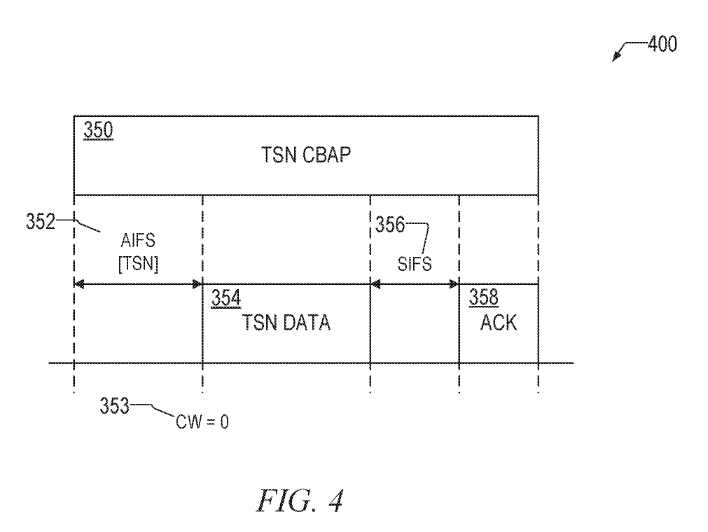

FIG. 4 is a timing diagram 400 illustrating the TSN CBAPs 350 access rules. In order to meet requirements for synchronous TSN flows, the access rules for TSN CBAPs 350 include a minimal arbitration interframe space (AIFS) 352 for TSN traffic (AIFS[TSN]), and a zero size contention window (CW) 353. Given that the TSN CBAP 350 could be allocated to a specific STA, no contention is expected and the STA should be able to find the medium idle and transmit a data frame 354 after the AIFS[TSN] 352. In one configuration, the AIFS[TSN] 352 parameter may be announced by the AP as part of an EDCA parameter set. A short interframe space (SIFS) 356 is provided after the TSN data 354, with an acknowledgement (ACK) 358 following.

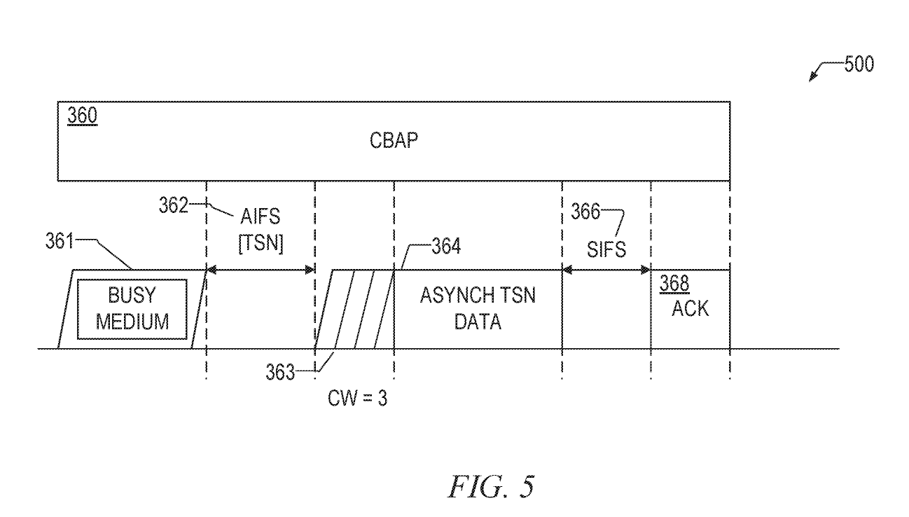

FIG. 5 is a timing diagram 500 illustrating access rules for TSN STAs in shared CBAPs 360. Shared CBAPs 360 could be used for transmission of asynchronous events from the TSN STA as well as non-TSN traffic (e.g., system monitoring and any other type of traffic). Shared CBAPs 360 could be used by TSN STAs to send asynchronous events with higher priority than non-TSN traffic, as discussed above. During a shared CBAP 360, TSN STAs have higher priority for accessing the channel by using an AIFS[TSN] 362, but in this case, since contention between TSN STAs is possible, a non-zero CW 363 (e.g., three) may be used. The shorter the AIFS[TSN] and CW values, the faster the STA can access the channel, which provides higher priority. In particular, if the CW is too small, it may increase the collision probability between TSN STAs if they try to access the medium at the same time. Therefore, there is a tradeoff between priority/latency and collision probability. In general, the AIFS[TSN] and CW should be smaller than the corresponding values for non-TSN STAs in order to ensure the TSN STAs get higher access priority. In one configuration, the CW value 363 for TSN STAs within a CBAP 360 could be announced by the AP as part of the EDCA parameter set.

In order to ensure higher priority to TSN STAs, the AIFS[TSN] value 362 should be smaller than any other AIFS[AC] value in the network. In the general enhanced distributed channel access (EDCA) mechanism in legacy IEEE 802.11e, there are several Access Categories (AC) defined (e.g., AC_VO—voice, AC_VI—video, AC_BE—best effort, AC_BK—background traffic). Each AC is identified by a number in the standard and each one has a specific AIFS value (i.e. AIFS[AC]=xx). Here, a new AC for TSN STAs is provided, which may give priority over all other ACs previously defined. Therefore, the AIFS for TSN (AIFS[TSN]) should be smaller than any other AIFS for other ACs.

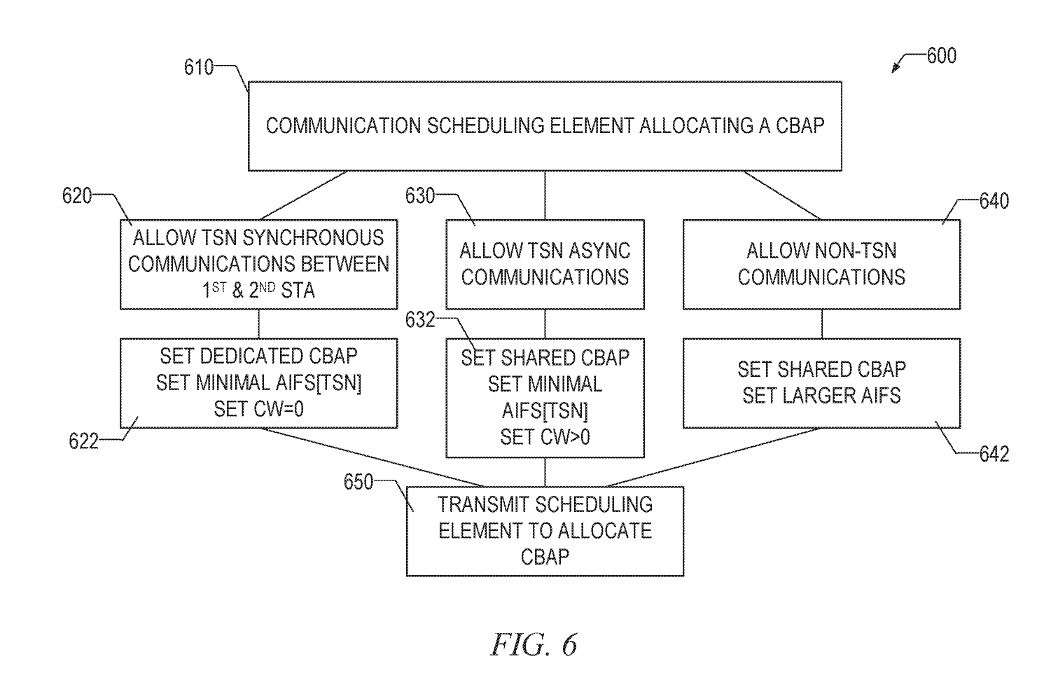

FIG. 6 is a flowchart 600 illustrating the allocation of the CBAPs as described above. A communication scheduling element for allocating a CBAP 610 for a particular type of communication is configured to create three different types of configurations. The first operation 620 allows for TSN synchronous communications between a first and second station STA, in which case, in operation 622, a dedicated CBAP is created, a minimal AIFS[TSN] is set, as is a CW=0, as described above. Operation 630 allows for asynchronous communications and sets a shared CBAP with a minimal AIFS[TSN]. Here, given the possibility of contention, the CW value is set >0. Finally, operation 640 allows for non-TSN communication, in which case a shared CBAP is created with a larger AIFS. TSN STAs operating according to 630 and non-TSN STA operating according to 640 may share the same CBAP, following their respective operation rules. It is also possible that a TSN STA may generate all three types of traffic (e.g., synchronous TSN flow, asynchronous TSN event and non-TSN data), and the STA may follow the appropriate operation rules for each type of traffic.

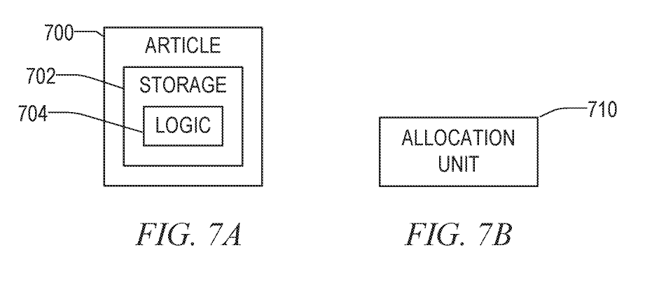

FIG. 7A is a block diagram of an example of an article of manufacture 700, in accordance with some demonstrative embodiments. Article 700 may include a non-transitory machine-readable storage medium 702 to store logic 704, which may be used, for example, to perform at least part of the functionality of elements shown in FIG. 1A, including device 102, device 130, device 140, wireless communication unit 104, wireless communication unit 162, wireless communication unit 132 and/or to perform one or more operations of the method of FIG. 3. FIG. 7B is a block diagram of an allocation unit 710 which performs allocations of CBAPs as described above, and which may be a part of the logic 704. The phrase “non-transitory machine-readable medium” is directed to include all computer-readable media, with the sole exception being a transitory propagating signal.

In some demonstrative embodiments, article 700 and/or machine-readable storage medium 702 may include one or more types of computer-readable storage media capable of storing data, including volatile memory, non-volatile memory, removable or non-removable memory, erasable or non-erasable memory, writeable or re-writeable memory, and the like. For example, machine-readable storage medium 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, for example, a modem, radio or network connection.

In some demonstrative embodiments, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 704 may include, or may be implemented as, software, a software module or circuit, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc. WiGig MAC and PHY Specification Version 1.1, June 2011, Final specification) and/or future versions and/or derivatives thereof, devices and/or networks operating in accordance with existing IEEE 802.11 standards (IEEE 802.11-2007, IEEE Standard for Information Technology-Telecommunications and information exchange between systems-Local and metropolitan area networks-Specific requirements. Part 11: Wireless LAN Medium Access Control (MAC) and Physical Layer (PHY) Specifications; IEEE 802.11n-2009, IEEE Standard for Information Technology-Telecommunications and information exchange between systems-Local and metropolitan area networks-Specific requirements, Part 11: Wireless LAN Medium Access Control (MAC) and Physical Layer (PHY) specifications, Amendment 5: Enhancements for Higher Throughput; IEEE802.11 task group ac (TGac) (“IEEE802.11-09/0308r12-TGac Channel Model Addendum Document”); IEEE 802.11ad-2012, 8802-11-2012 Amd.3—2014; IEEE 802.11 task group ad (TGad) (IEEE P802.11ad/D1.0 Draft Standard for Information Technology-Telecommunications and Information Exchange Between Systems-Local and Metropolitan Area Networks-Specific Requirements-Part 11: Wireless LAN Medium Access Control (MAC) and Physical Layer (PHY) Specifications-Amendment 5: Enhancements for Very High Throughput in the 60 GHz Band), and/or future versions and/or derivatives thereof, devices and/or networks operating in accordance with existing IEEE 802.16 standards (IEEE-Std 802.16, 2009 Edition, Air Interface for Fixed Broadband Wireless Access Systems; IEEE-Std 802.16e, 2005 Edition. Physical and Medium Access Control Layers for Combined Fixed and Mobile Operation in Licensed Bands; amendment to IEEE Std 802.16-2009, developed by Task Group m) and/or future versions and/or derivatives thereof, devices and/or networks operating in accordance with existing Wireless-WirelessHD™ specifications and/or future versions and/or derivatives thereof units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, for example, a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi. Wi-Max. ZigBee™, Ultra-Wideband (UWB), Global System for Mobile communication (GSM), 2G, 2.5G, 3G, 3.5G, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some embodiments, a wireless device may be or may include a peripheral that is integrated with a computer, or a peripheral that is attached to a computer. In some embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments may be used in conjunction with suitable limited-range or short-range wireless communication networks, for example, a wireless area network, a “piconet”, a WPAN, a WVAN and the like. Other embodiments may be used in conjunction with any other suitable wireless communication network.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmwave) frequency band), for example, a frequency band within the frequency band of between 30 Ghz and 300 GHZ, a WLAN frequency band, a WPAN frequency band, a frequency band according to the WGA specification, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The term “station” (STA), as used herein, may include any logical entity that is a singly addressable instance of a medium access control (MAC) and a physical layer (PHY) interface to a wireless medium (WM). The phrase “access point” (AP), as used herein, may include an entity that contains one station (STA) and provides access to distribution services, via the WM for associated STAs. The term “beamforming”, as used herein, may relate to a spatial filtering mechanism, which may be used at a transmitter and/or a receiver to improve the received signal power or signal-to-noise ratio (SNR) at an intended receiver. The phrase “non-access-point (non-AP) station (STA)”, as used herein, may relate to a STA that is not contained within an AP. The phrase “service period” (SP), as used herein, may relate to a contiguous time during which one or more individually addressed frames are transmitted to a STA, for example a quality of service (QoS) STA, and/or one or more transmission opportunities (TxOPs) are granted to the same STA.

The phrases “directional multi-gigabit (DMG)” and “directional band” (DBand), as used herein, may relate to a frequency band wherein the Channel starting frequency is above 56 GHz. The phrases “DMG STA” and “mmWave STA (mSTA)” may relate to a STA having a radio transmitter, which is operating on a channel that is within the DMG band. The phrase “personal basic service set” (PBSS), as used herein, may relate to a basic service set (BSS) that forms a self-contained network. For example, the PBSS may operate in the DMG band, and may include one PBSS control point (PCP). The phrase “PBSS control point” (PCP), as used herein, may include an entity that contains one station (STA) and coordinates access to the WM by STAs that are members of a PBSS. The phrase “non-PCP station (STA)”, as used herein, may relate to a STA that is not also a PCP. The phrase “non-PCP/non-AP station (STA)”, as used herein, may relate to a STA that is not a PCP and that is not an AP. The phrase “PCP/AP”, as used herein, may relate to a STA that is a PCP or an AP.

The phrase “Contention Based Access Period (CBAP)”, as used herein, may relate to a time period, during which wireless communication devices may be allowed to communicate using a suitable contention-based mechanism. In one example, the CBAP may include an access period allocated within a Data Transfer Time (DTT) within a beacon interval (BI). The CBAP may include, for example, a time period within the DTT of a DMG Basic Service Set (BSS), where Enhanced Distributed Channel Access (EDCA) is used.

The phrase “Transmit Opportunity (TxOP)”, as used herein may relate to an interval of time when a particular STA, for example, a QoS STA, has the right to initiate frame exchange sequences onto the WM. A TxOP may be defined, for example, by a starting time and a maximum duration and/or any other parameters. In one example, the TxOP may be obtained by the STA by successfully contending for the channel or assigned by a coordinator.

Functions, operations, components and/or features described herein with reference to one or more embodiments, may be combined with, or may be utilized in combination with, one or more other functions, operations, components and/or features described herein with reference to one or more other embodiments, or vice versa.

For the purposes of promoting an understanding of the principles of this disclosure, reference has been made to the various configurations illustrated in the drawings, and specific language has been used to describe these configurations. However, no limitation of the scope of the inventive subject matter is intended by this specific language, and the inventive subject matter should be construed to encompass all embodiments and configurations that would normally occur to one of ordinary skill in the art. The configurations herein may be described in terms of functional block components and various processing steps. Such functional blocks may be realized by any number of components that perform the specified functions. The particular implementations shown and described herein are illustrative examples and are not intended to otherwise limit the scope of the inventive subject matter in any way. The connecting lines, or connectors shown in the various figures presented may, in some instances, be intended to represent example functional relationships and/or physical or logical couplings between the various elements. However, many alternative or additional functional relationships, physical connections or logical connections may be present in a practical device. Moreover, no item or component is essential unless the element is specifically described as “essential” or “critical”. Numerous modifications and adaptations will be readily apparent to those skilled in this art.

Example 1 is an apparatus of a wireless communication station (STA), the apparatus comprising: memory; and an allocation unit comprising processing circuitry, configured to: allocate a dedicated time-sensitive network (TSN) contention-based-access-period (CBAP) to a first pair of stations (STAs) to allow a synchronous TSN traffic flow between the first pair of STAs; allocate a shared TSN CBAP to a second pair of STAs to allow an asynchronous TSN traffic flow between the second pair of STAs by use of contention-based rules; and allocate a shared non-TSN CBAP to a third pair of STAs to allow a non-TSN traffic flow between the third pair of STAs; and encode for transmission, a first schedule element to schedule the dedicated TSN CBAP, a second schedule element to schedule the shared TSN CBAP, and a third schedule element to schedule the shared non-TSN CBAP.

In Example 2, the subject matter of Example 1 optionally includes wherein the allocation unit is configured to allocate a shared CBAP to the second pair of STAs to allow both the asynchronous TSN traffic flow between the second pair of STAs and non-TSN traffic flow.

In Example 3, the subject matter of Example 2 optionally includes wherein the allocation unit, when it allocates the shared CBAP, is configured to set a contention window (CW) between a minimal arbitration interframe space (AIFS) and TSN data to a non-zero value for the asynchronous TSN traffic flow that differs from Enhanced Distributed Channel Access (EDCA) parameter set values for other traffic flows.

In Example 4, the subject matter of any one or more of Examples 1-3 optionally include wherein the allocation unit, when it allocates the shared TSN CBAP, is configured to set a minimal arbitration interframe space (AIFS).

In Example 5, the subject matter of Example 4 optionally includes wherein the allocation unit, when it allocates the shared TSN CBAP, is configured to announce the AIFS.

In Example 6, the subject matter of Example 5 optionally includes wherein the allocation unit, when it allocates the shared TSN CBAP, includes the AIFS as part of an Enhanced Distributed Channel Access (EDCA) parameter set.

In Example 7, the subject matter of any one or more of Examples 1-6 optionally include wherein the allocation unit is configured to allocate a shared TSN CBAP to the second pair of STAs to allow both the asynchronous TSN traffic flow between the second pair of STAs and non-TSN traffic flow.

In Example 8, the subject matter of any one or more of Examples 1-7 optionally include wherein the allocation unit, when it allocates the dedicated TSN CBAP, is configured to: set a source association identification (AID) field of the dedicated TSN CBAP to identify a first STA of the first pair of STAs; and set a destination AID field of the dedicated TSN CBAP to identify a second STA of the first pair of STAs.

In Example 9, the subject matter of any one or more of Examples 1-8 optionally include wherein the allocation unit, when it allocates the dedicated TSN CBAP, is configured to: set a source association identification (AID) field of the dedicated TSN CBAP to identify a first STA of the first pair of STAs; and set a destination AID field of the dedicated TSN CBAP to a group ID in a form of a multicast or broadcast.

In Example 10, the subject matter of any one or more of Examples 1-9 optionally include wherein the allocation unit, when it allocates the dedicated TSN CBAP, is configured to set a contention window (CW) between a minimal arbitration interframe space (AIFS) and TSN data to a zero value.

In Example 11, the subject matter of any one or more of Examples 1-10 optionally include wherein the allocation unit, when it allocates the dedicated TSN CBAP, is configured to set a minimal arbitration interframe space (AIFS).

In Example 12, the subject matter of any one or more of Examples 1-11 optionally include wherein the allocation unit, when it allocates the dedicated TSN CBAP, is configured to announce the AIFS.

In Example 13, the subject matter of Example 12 optionally includes wherein the allocation unit, when it announces the AIFS, includes the AIFS as part of an Enhanced Distributed Channel Access (EDCA) parameter set.

In Example 14, the subject matter of any one or more of Examples 1-13 optionally include an antenna; and a transmitter operably connected to the antenna and configured to transmit the encoded first schedule element, the second schedule element, and the third schedule element.

In Example 15, the subject matter of Example 14 optionally includes wherein the antenna is a phased-array antenna.

In Example 16, the subject matter of Example 15 optionally includes wherein the transmitter is configured to transmit a directional multi-gigabit data stream

Example 17 is a method to be performed by either a personal basic service set control point (PCP) or an access point (AP), the method comprising, over a wireless communication medium: transmitting a scheduling element to allocate a dedicated time-sensitive network (TSN) contention-based-access-period (CBAP) to a first pair of stations (STAs) to allow a synchronous TSN traffic flow between the first pair of STAs; transmitting a scheduling element to allocate a shared TSN CBAP to a second pair of STAs to allow an asynchronous TSN traffic flow between the second pair of STAs using contention-based rules; and transmitting a scheduling element to allocate a shared non-TSN CBAP to a third pair of STAs to allow a non-TSN traffic flow between the third pair of STAs.

In Example 18, the subject matter of Example 17 optionally includes transmitting a scheduling element to allocate a shared CBAP to the second pair of STAs to allow both the asynchronous TSN traffic flow and non-TSN traffic flow between the second pair of STAs.

In Example 19, the subject matter of any one or more of Examples 17-18 optionally include prior to transmitting the dedicated TSN CBAP: setting a source association identification (AID) field of the dedicated TSN CBAP to identify a first STA of the first pair of STAs; and setting a destination AID field of the dedicated TSN CBAP to identify at least one of: a) a second STA of the first pair of STAs; and b) a group of STAs in a form of a multicast or broadcast.

In Example 20, the subject matter of any one or more of Examples 17-19 optionally include prior to transmitting the dedicated TSN CBAP, setting a contention window (CW) between a minimal arbitration interframe space (AIFS) and TSN data to a zero value.

In Example 21, the subject matter of any one or more of Examples 17-20 optionally include prior to transmitting the dedicated TSN CBAP, setting a minimal arbitration interframe space (AIFS).

In Example 22, the subject matter of Example 21 optionally includes prior to transmitting the dedicated TSN CBAP, announcing the AIFS as part of an Enhanced Distributed Channel Access (EDCA) parameter set.

In Example 23, the subject matter of any one or more of Examples 17-22 optionally include prior to transmitting the shared TSN CBAP, setting a contention window (CW) between a minimal arbitration interframe space (AIFS) and TSN data to a non-zero value.

Example 24 is a computer program product comprising one or more tangible computer readable non-transitory storage media comprising computer-executable instructions operable to, when executed by processing circuitry of a device, configure the station to perform any of the methods of Examples 17-23.

Example 25 is a system comprising means to perform any of the methods of Examples 17-23.

Example 26 is a computer program product comprising one or more tangible computer readable non-transitory storage media comprising computer-executable instructions operable to, when executed by processing circuitry of a station, configure the station to: transmit a scheduling element to allocate a dedicated time-sensitive network (TSN) contention-based-access-period (CBAP) to a first pair of stations (STAs) to allow a synchronous TSN traffic flow between the first pair of STAs; transmit a scheduling element to allocate a shared TSN CBAP to a second pair of STAs to allow an asynchronous TSN traffic flow between the second pair of STAs using contention-based rules; and transmit a scheduling element to allocate a shared non-TSN CBAP to a third pair of STAs to allow a non-TSN traffic flow between the third pair of STAs.

In Example 27, the subject matter of Example 26 optionally includes wherein the instructions are further operable to configure the station to: set a source association identification (AID) field of the dedicated TSN CBAP to identify a first STA of the first pair of STAs; and set a destination AID field of the dedicated TSN CBAP to a group ID in a form of a multicast or broadcast.

Example 28 is an apparatus of a wireless communication station (STA), the apparatus comprising: means for transmitting a scheduling element to allocate a dedicated time-sensitive network (TSN) contention-based-access-period (CBAP) to a first pair of stations (STAs) to allow a synchronous TSN traffic flow between the first pair of STAs; means for transmitting a scheduling element to allocate a shared TSN CBAP to a second pair of STAs to allow an asynchronous TSN traffic flow between the second pair of STAs using contention-based rules; and means transmitting a scheduling element to allocate a shared non-TSN CBAP to a third pair of STAs to allow a non-TSN traffic flow between the third pair of STAs.

In Example 29, the subject matter of Example 28 optionally includes means for transmitting a scheduling element to allocate a shared CBAP to the second pair of STAs to allow both the asynchronous TSN traffic flow and non-TSN traffic flow between the second pair of STAs.

In Example 30, the subject matter of any one or more of Examples 28-29 optionally include means for, prior to transmitting the dedicated TSN CBAP: setting a source association identification (AID) field of the dedicated TSN CBAP to identify a first STA of the first pair of STAs; and setting a destination AID field of the dedicated TSN CBAP to identify at least one of: a) a second STA of the first pair of STAs; and b) a group of STAs in a form of a multicast or broadcast.

In Example 31, the subject matter of any one or more of Examples 28-30 optionally include means for, prior to transmitting the dedicated TSN CBAP, setting a contention window (CW) between a minimal arbitration interframe space (AIFS) and TSN data to a zero value.

In Example 32, the subject matter of any one or more of Examples 28-31 optionally include means for, prior to transmitting the dedicated TSN CBAP, setting a minimal arbitration interframe space (AIFS).

In Example 33, the subject matter of Example 32 optionally includes means for, prior to transmitting the dedicated TSN CBAP, announcing the AIFS as part of an Enhanced Distributed Channel Access (EDCA) parameter set.

In Example 34, the subject matter of any one or more of Examples 28-33 optionally include means for, prior to transmitting the shared TSN CBAP, setting a contention window (CW) between a minimal arbitration interframe space (AIFS) and TSN data to a non-zero value.

What is claimed is:

1. An apparatus of a wireless communication station (STA), the apparatus comprising: memory; and processing circuitry, configured to:
allocate a dedicated time-sensitive network (TSN) contention-based-access-period (CBAP) to a first pair of stations (STAs) to allow a synchronous TSN traffic flow between the first pair of STAs;
allocate a shared TSN CBAP to a second pair of STAs to allow an asynchronous TSN traffic flow between the second pair of STAs by use of contention-based rules; and
allocate a shared non-TSN CBAP to a third pair of STAs to allow a non-TSN traffic flow between the third pair of STAs; and
encode for transmission, a first schedule element to schedule the dedicated TSN CBAP, a second schedule element to schedule the shared TSN CBAP, and a third schedule element to schedule the shared non-TSN CBAP.

2. The apparatus of claim 1, wherein the processing circuitry is configured to allocate a shared CBAP to the second pair of STAs to allow both the asynchronous TSN traffic flow between the second pair of STAs and non-TSN traffic flow.

3. The apparatus of claim 2, wherein the processing circuitry, when it allocates the shared CBAP, is configured to set a contention window (CW) between a minimal arbitration interframe space (AIFS) and TSN data to a non-zero value for the asynchronous TSN traffic flow that differs from Enhanced Distributed Channel Access (EDCA) parameter set values for other traffic flows.

4. The apparatus of claim 1, wherein the processing circuitry, when it allocates the shared TSN CBAP, is configured to set a minimal arbitration interframe space (AIFS).

5. The apparatus of claim 4, wherein the processing circuitry, when it allocates the shared TSN CBAP, is configured to announce the AIFS.

6. The apparatus of claim 5, wherein the processing circuitry, when it allocates the shared TSN CBAP, includes the AIFS as part of an Enhanced Distributed Channel Access (EDCA) parameter set.

7. The apparatus of claim 1, wherein the processing circuitry is configured to allocate a shared TSN CBAP to the second pair of STAs to allow both the asynchronous TSN traffic flow between the second pair of STAs and non-TSN traffic flow.

8. The apparatus of claim 1, wherein the processing circuitry, when it allocates the dedicated TSN CBAP, is configured to:
set a source association identification (AID) field of the dedicated TSN CBAP to identify a first STA of the first pair of STAs; and
set a destination AID field of the dedicated TSN CBAP to identify a second STA of the first pair of STAs.

9. The apparatus of claim 1, wherein the processing circuitry, when it allocates the dedicated TSN CBAP, is configured to:
set a source association identification (AID) field of the dedicated TSN CBAP to identify a first STA of the first pair of STAs; and
set a destination AID field of the dedicated TSN CBAP to a group ID in a form of a multicast or broadcast.

10. The apparatus of claim 1, wherein the processing circuitry, when it allocates the dedicated TSN CBAP, is configured to set a contention window (CW) between a minimal arbitration interframe space (AIFS) and TSN data to a zero value.

11. The apparatus of claim 1, wherein the processing circuitry, when it allocates the dedicated TSN CBAP, is configured to set a minimal arbitration interframe space (AIFS).

12. The apparatus of claim 1, wherein the processing circuitry, when it allocates the dedicated TSN CBAP, is configured to announce the AIFS.

13. The apparatus of claim 12, wherein the processing circuitry, when it announces the AIFS, includes the AIFS as part of an Enhanced Distributed Channel Access (EDCA) parameter set.

14. The apparatus of claim 1, further comprising:
an antenna; and
a transmitter operably connected to the antenna and configured to transmit the encoded first schedule element, the second schedule element, and the third schedule element.

15. The apparatus of claim 14, wherein the antenna is a phased-array antenna.

16. The apparatus of claim 15, wherein the transmitter is configured to transmit a directional multi-gigabit data stream.

17. A method to be performed by either a personal basic service set control point (PCP) or an access point (AP), the method comprising, over a wireless communication medium:
transmitting a scheduling element to allocate a dedicated time-sensitive network (TSN) contention-based-access-period (CBAP) to a first pair of stations (STAs) to allow a synchronous TSN traffic flow between the first pair of STAs;
transmitting a scheduling element to allocate a shared TSN CBAP to a second pair of STAs to allow an asynchronous TSN traffic flow between the second pair of STAs using contention-based rules; and
transmitting a scheduling element to allocate a shared non-TSN CBAP to a third pair of STAs to allow a non-TSN traffic flow between the third pair of STAs.

18. The method of claim 17, further comprising transmitting a scheduling element to allocate a shared CBAP to the second pair of STAs to allow both the asynchronous TSN traffic flow and non-TSN traffic flow between the second pair of STAs.

19. The method of claim 17, further comprising, prior to transmitting the dedicated TSN CBAP:
setting a source association identification (AID) field of the dedicated TSN CBAP to identify a first STA of the first pair of STAs; and
setting a destination AID field of the dedicated TSN CBAP to identify at least one of: a) a second STA of the first pair of STAs; and b) a group of STAs in a form of a multicast or broadcast.

20. The method of claim 17, further comprising, prior to transmitting the dedicated TSN CBAP, setting a contention window (CW) between a minimal arbitration interframe space (AIFS) and TSN data to a zero value.

21. The method of claim 17, further comprising, prior to transmitting the dedicated TSN CBAP, setting a minimal arbitration interframe space (AIFS).

22. The method of claim 21, further comprising, prior to transmitting the dedicated TSN CBAP, announcing the AIFS as part of an Enhanced Distributed Channel Access (EDCA) parameter set.

23. The method of claim 17, further comprising, prior to transmitting the shared TSN CBAP, setting a contention window (CW) between a minimal arbitration interframe space (AIFS) and TSN data to a non-zero value.

24. A computer program product comprising one or more tangible computer readable non-transitory storage media comprising computer-executable instructions operable to, when executed by processing circuitry of a station, configure the station to:
transmit a scheduling element to allocate a dedicated time-sensitive network (TSN) contention-based-access-period (CBAP) to a first pair of stations (STAs) to allow a synchronous TSN traffic flow between the first pair of STAs;
transmit a scheduling element to allocate a shared TSN CBAP to a second pair of STAs to allow an asynchronous TSN traffic flow between the second pair of STAs using contention-based rules; and
transmit a scheduling element to allocate a shared non-TSN CBAP to a third pair of STAs to allow a non-TSN traffic flow between the third pair of STAs.

25. The computer program product of claim 24, wherein the instructions are further operable to configure the station to:
set a source association identification (AID) field of the dedicated TSN CBAP to identify a first STA of the first pair of STAs; and
set a destination AID field of the dedicated TSN CBAP to a group ID in a form of a multicast or broadcast.
